(19) United States
(12) Patent Application Publication
(10) Pub. No.: US 2015/0180163 A1
(43) Pub. Date: Jun. 25, 2015

(54) CONNECTOR

(71) Applicant: YAZAKI CORPORATION, Tokyo (JP)

(72) Inventor: Masayuki SAITOH, Makinohara-shi (JP)

(73) Assignee: YAZAKI CORPORATION, Tokyo (JP)

(21) Appl. No.: 14/636,875

(22) Filed: Mar. 3, 2015

Related U.S. Application Data
(63) Continuation of application No. PCT/JP2013/073668, filed on Sep. 3, 2013.

(30) Foreign Application Priority Data
Sep. 7, 2012 (JP) 2012-196881

(51) Int. Cl. H01R 13/533; H01R 13/502

(52) U.S. Cl. CPC H01R 13/533; H01R 13/502

(57) ABSTRACT

A connector includes a female connector, a male connector and an electric wire regulation cover. The female connector includes a fitting hood portion including male terminal portions projecting therein. The male connector is fitted into the fitting hood portion and houses female terminals to be connected to the male terminal portions. An inner wall of the fitting hood portion is provided with projection insertion grooves elongated in the insertion direction of the male connector. A cover body portion is formed in the electric wire regulation cover to cover the rear end portion of the male connector. The cover body portion is provided, on an front end portion thereof, with projections inserted between the projection insertion grooves and an outer circumferential surface of the male connector so as to fill gaps between the inner wall of the fitting hood portion and the outer circumferential surface of the male connector.

### CROSS REFERENCE TO RELATED APPLICATION

This is a continuation application based on PCT application No. PCT/JP2013/073668 filed on Sep. 3, 2013, which claims the benefit of priority from Japanese Patent Application No. 2012-196881 filed on Sep. 7, 2012, the entire contents of which are incorporated by reference herein.

### BACKGROUND OF THE INVENTION

1. Field of the Invention

The present invention relates to a connector, and more particularly, to a connector to which an electric wire regulation cover is attached.

2. Description of the Related Art

A conventional connector includes a male connector and a female connector, the fame connector being fitted into the female connector. One of the male connector and the female connector is provided with terminals therein, and the other one includes conductive members housed therein. The terminals of the one connector come into contact with the conductive members of the other connector so that the conductive members are electrically connected to the terminals. A plurality of electric wires are connected to the terminals of the one connector so that electricity flows into the conductive members through the plurality of electric wires. The plurality of electric wires are drawn out of the one connector on one end side (on an electric wire drawing side). An electric wire regulation cover is attached to the electric wire drawing side of the one connector. The electric wire regulation cover is used to collect the plurality of electric wires drawn out of the one connector (refer to Japanese Unexamined Patent Application Publication No. 2004-350342) so as to regulate the movement of the plurality of electric wires in one direction.

In the conventional connector, when the electric wire regulation cover is attached to the electric wire drawing side of the male connector or the female connector, the weight of the connector to which the electric wire regulation cover is attached increases. Thus, there is a problem of a decrease in oscillation resistance of the connector to which the electric wire regulation cover is attached since the connector to which the electric wire regulation cover is attached tends to oscillate if there is a gap between the inner wall of the female connector and the outer circumferential surface of the male connector when the male connector is fitted into the female connector.

### SUMMARY OF THE INVENTION

An object of the present invention is to provide a connector capable of improving oscillation resistance of a connector to which an electric wire regulation cover is attached on an electric wire drawing side (on the rear side of the connector).

According to a first aspect of the present invention, there is provided a connector including: a female connector including a fitting hood portion provided with male terminal portions projecting therein; a male connector fitted into the fitting hood portion of the female connector and including female terminal housing portions for housing female terminals to be connected to the male terminal portions of the female connector, the female terminals being connected with a plurality of electric wires drawn out of a rear end portion of the male connector; and an electric wire regulation cover fixed to the rear end portion of the male connector to collect the plurality of electric wires drawn out of the male connector, wherein an inner wall of the fitting hood portion of the female connector is provided with a projection insertion groove elongated in an insertion direction of the male connector, a cover body portion is formed in the electric wire regulation cover to cover the rear end portion of the male connector, and the cover body portion is provided, on an front end portion thereof, with a projection inserted between the projection insertion groove of the female connector and an outer circumferential surface of the male connector so as to fill a gap between the inner wall of the fitting hood portion and the outer circumferential surface of the male connector.

According to a second aspect of the present invention, the projection is provided with a fixed piece projecting toward the fitting hood portion of the female connector, the fitting hood portion of the female connector is provided with a fixing portion to which the fixed piece is fixed, and the fixed piece is fixed to the fixing portion so that the electric wire regulation cover is attached to the male connector.

According to a third aspect of the present invention, the rear end portion of the male connector is provided with a projection insertion guide portion for guiding the projection into the gap between the inner wall of the fitting hood portion and the outer circumferential surface of the male connector.

According to the first aspect of the present invention, the cover body portion is provided, on the front end portion thereof, with the projection inserted between the projection insertion groove of the female connector and the outer circumferential surface of the male connector so as to fill the gap between the inner wall of the fitting hood portion and the outer circumferential surface of the male connector. Thus, the gap between the male connector and the female connector can be filled with the projection formed in the electric wire regulation cover to be inserted into the gap.

According to the second aspect of the present invention, the fixed piece formed in the projection is fixed to the fixing portion formed on a side wall of the female connector so that the electric wire regulation cover can reliably be fixed to the female connector.

According to the third aspect of the present invention, the rear end portion of the male connector is provided with a projection insertion guide portion for guiding the projection into the gap between the inner wall of the fitting hood portion and the outer circumferential surface of the male connector. Accordingly, the projection can reliably be guided into the projection insertion groove.

### BRIEF DESCRIPTION OF THE DRAWINGS

FIG. 1 is an exploded perspective view of a connector according to an embodiment of the present invention.

FIG. 2 is a perspective view showing a process of assembling the connector according to the embodiment of the present invention.

FIG. 3 is a perspective view showing a completion state of the assembled connector according to the embodiment of the present invention.

FIG. 4A is a top view of the connector according to the embodiment of the present invention.

FIG. 4B is a cross-sectional view taken along line A-A of FIG. 4A.

FIG. 5 is a perspective view showing a process of assembling a connector according to a modified example of the embodiment of the present invention.

FIG. 6 is a perspective view showing a completion state of the assembled connector according to the modified example of the embodiment of the present invention.

### DESCRIPTION OF THE EMBODIMENTS

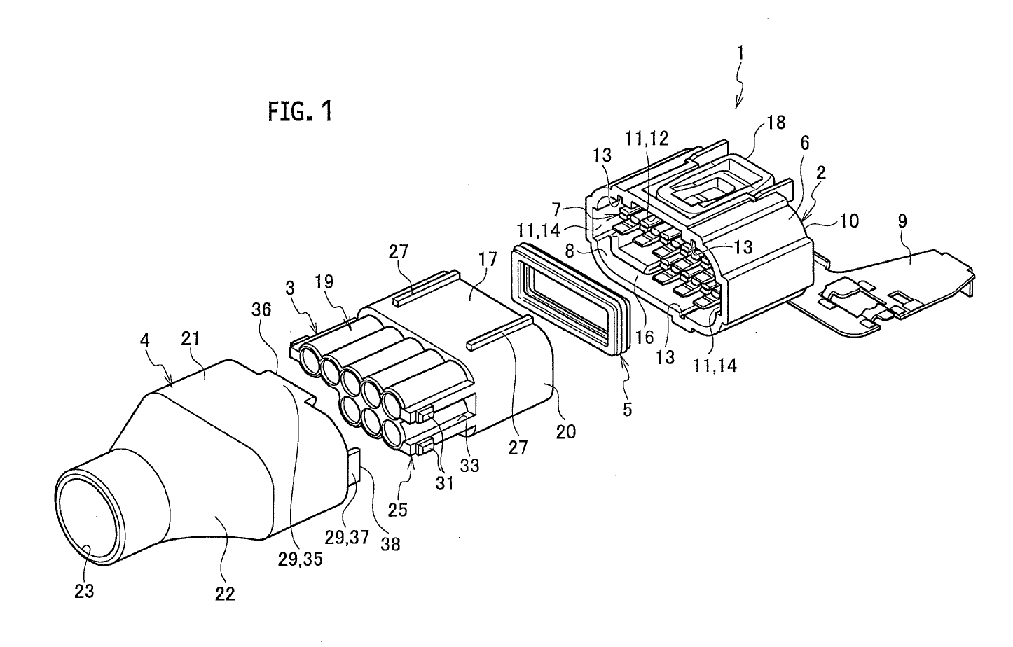

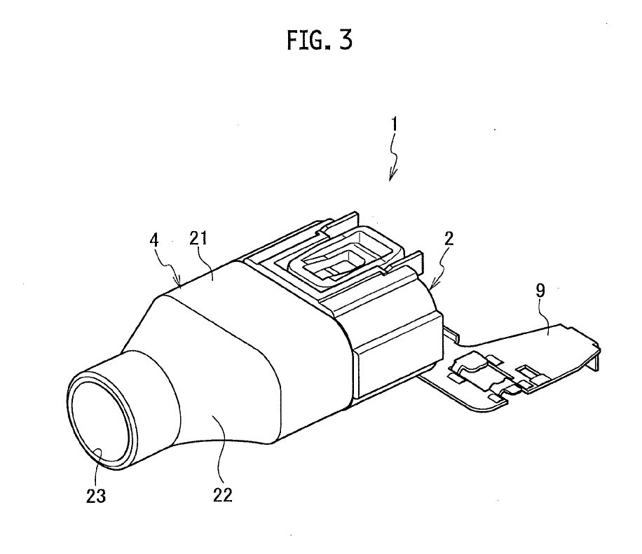

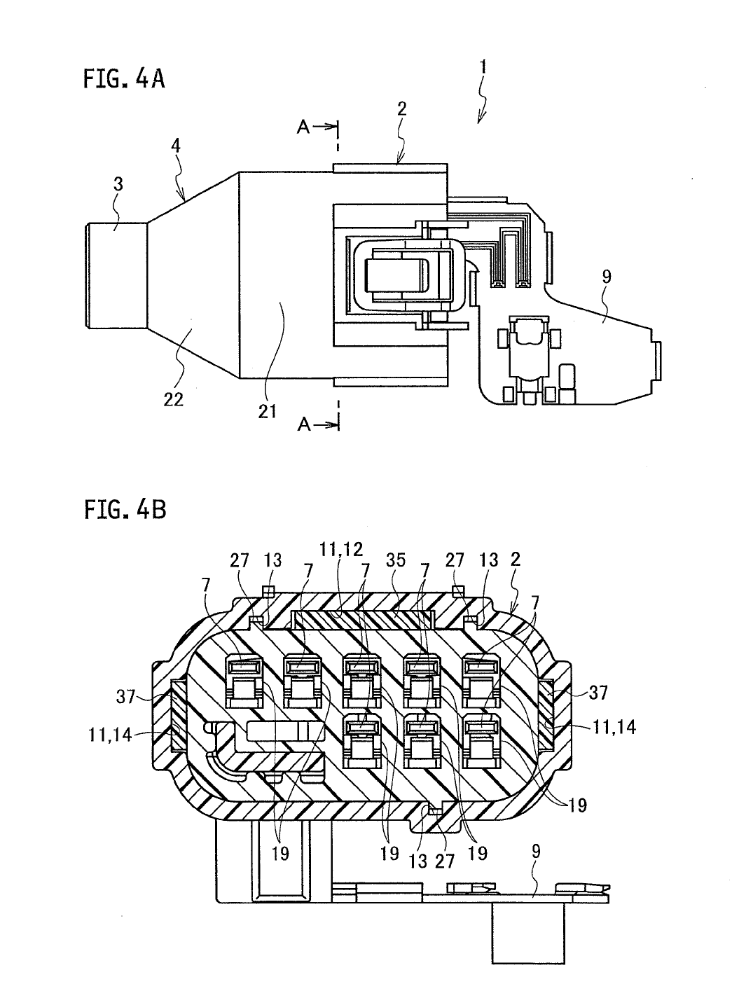

The embodiment of the present invention will be described below with reference to FIG. 1 to FIG. 6. Note that, in the present embodiment, a direction coming closer to a mating connector is a front side, and a direction away from the mating connector is a rear side.

As shown in FIG. 1 to FIG. 4B, a connector 1 includes a female connector 2, a male connector 3, an electric wire regulation cover 4 and a packing 5. The female connector 2 includes a fitting hood portion 6 for housing male terminal portions 7 projecting therein. The male connector 3 is fitted into the fitting hood portion 6 of the female connector 2 and includes female terminal housing portions 19 for housing female terminals (not shown in the figures) to be connected to the male terminal portions 7 of the female connector 2. A plurality of electric wires are connected to the female terminals of the female terminal housing portions 19 and drawn out of the male connector 3 on an electric wire drawing side (on the rear side). The electric wire regulation cover 4 is attached to the male connector 3 on the electric wire drawing side to collect the plurality of electric wires drawn out of the male connector 3. The packing 5 is placed in the female connector 2 and held between a bottom wall 10 of the female connector 2 and an edge portion of the male connector 3.

The female connector 2 further includes a male terminal housing portion 16 and a fixing portion 9. The male terminal housing portion 16 is fitted to the fitting hood portion 6 of the female connector 2 to house the male terminal portions 7 to be connected to the female terminals. The fixing portion 9 is formed at one edge of the female connector 2.

The fitting hood portion 6 is formed substantially into a square tube open on one side and includes a side wall 8 and the bottom wall 10. The side wall 8 includes male connector guide grooves 13 for guiding the male connector 3 being inserted therein and projection insertion grooves 11 into which projections 29 of the electric wire regulation cover 4 are to be inserted, the male connector guide grooves 13 and the projection insertion grooves 11 being formed on the inner circumference of the side wall 8 and elongated in the insertion direction of the male connector 3 and the electric wire regulation cover 4. The side wall 8 further includes, on the outer circumference, a lock means 18 for fixing another connector to a fixing portion. The packing 5 is placed to be in contact with the bottom wall 10 of the fitting hood portion 6 on the inner circumferential side.

The projection insertion grooves 11 formed on the inner circumference of the side wall 8 project from the inner wall side to the outer wall side of the side wall 8. The projections 29 of the electric wire regulation cover 4 are press-fitted into the corresponding projection insertion grooves 11.

The male terminal housing portion 16 is formed inside the fitting hood portion 6 to house the male terminal portions 7. The male terminal portions 7 placed inside the male terminal housing portion 16 project toward the opening from the bottom wall 10.

The fixing portion 9 is fixed to a desired fixing portion of the side wall 8 of the female connector 2 and extends therefrom.

The male connector 3 includes the female terminal housing portions 19. The female terminal housing portions 19 are provided with a body portion 17 on the front end side thereof to house the female terminals (not shown in the figures), the body portion 17 being formed to have an outer diameter which is substantially the same as the inner diameter of the male terminal housing portion 16.

The body portion 17 is formed into substantially the same shape as the inner circumference of the fitting hood portion 6 so as to be inserted into the male terminal housing portion 16 of the female connector 2.

The female terminals housed in the female terminal housing portions 19 are electrically connected to the male terminal portions 7 of the female connector 2.

The male connector 3 includes projection insertion guide portions 25 and guide projections 27. The projection insertion guide portions 25 project and extend along the female terminal housing portions 19 of the male connector 3. The guide projections 27 are formed on the outer circumference of the body portion 17 to guide the insertion of the male connector 3 into the female connector 2. The guide projections 27 are placed at several portions on the outer circumferential surface 20 of the body portion 17.

The projection insertion guide portions 25 include fixed portions 31 to be fixed to the electric wire regulation cover 4 and recesses 33 for guiding the electric wire regulation cover 4 to be attached to the male connector 3.

The fixed portions 31 project in a direction perpendicular to the insertion direction of the male connector 3 toward the female connector 2. The fixed portions 31 are fixed to fixing means (not shown in the figures) formed inside the electric wire regulation cover 4 so that the male connector 3 is fixed to the electric wire regulation cover 4.

The recesses 33 are formed at the female terminal housing portions 19 together with the fixed portions 31. The recesses 33 are elongated in the insertion direction of the projections 29 of the electric wire regulation cover 4 so as to guide the projections 29 to the female connector 2.

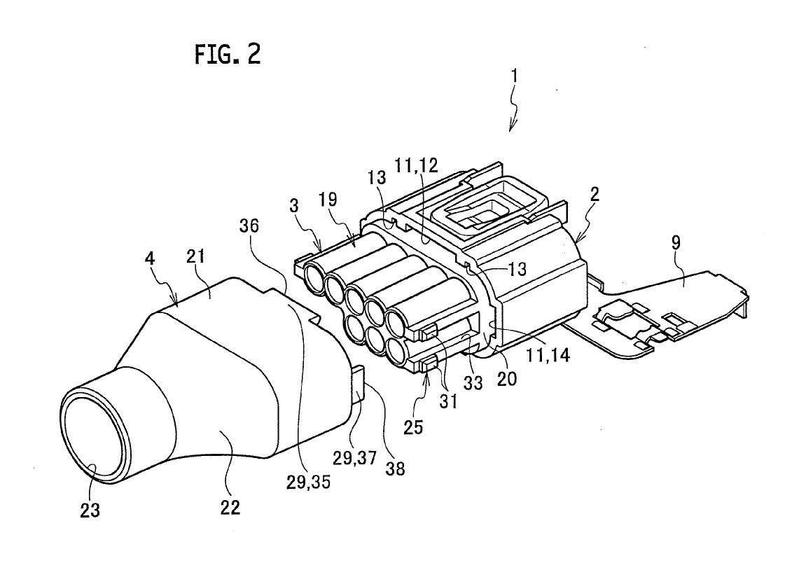

As shown in FIG. 2, the electric wire regulation cover 4 includes a cover body portion 21, an electric wire collecting portion 22 and an electric wire insertion hole 23. The cover body portion 21 covers rear ends of the female terminal housing portions 19 of the male connector 3. The electric wire collecting portion 22 collects the plurality of electric wires drawn out of the male connector 3. The plurality of electric wires collected by the electric wire collecting portion 22 is drawn out from the electric wire insertion hole 23.

The cover body portion 21 is attached to the male connector 3 to cover the rear ends of the female terminal housing portions 19. The cover body portion 21 is provided with the projections 29 projecting on the front side (at the front end portion) thereof in the attached and inserted direction of the cover body portion 21. The thickness of the projections 29 is set to be greater than the projection height of the projection insertion grooves 11.

The projections 29 are preferably provided at several portions on the front side (at the front end portion) of the cover body portion 21 in the insertion direction thereof. According to the present embodiment, the projections 29 provided in the cover body portion 21 are a long-side projection 35 formed on one long side of the electric wire regulation cover 4 and two short-side projections 37 formed on both short sides of the electric wire regulation cover 4.

The projections 29 may be provided, on the inner wall side thereof, with regulation portions which are regulated by the recesses 33 of the projection insertion guide portions 25. Further, a tip portion 36 of the long-side projection 35 and tip portions 38 of the short-side projections 37 may be provided with inclined surfaces so as to facilitate the attachment of the cover body portion 21.

The electric wire collecting portion 22 is connected and integrated to the cover body portion 21. The electric wire collecting portion 22 is provided, on the inner side thereof, with an inclined surface inclined to the electric wire insertion hole 23 so as to collect the plurality of electric wires toward the electric wire insertion hole 23.

The electric wire insertion hole 23 is connected and integrated to the electric wire collecting portion 22. The plurality of electric wires collected by the electric wire collecting portion 22 is drawn out from the electric wire insertion hole 23.

Next, a method of assembling the connector will be described below.

First, the packing 5 is attached to the bottom wall 10 of the female connector 2, and the male connector 3 is then inserted into the female connector 2. When the male connector 3 is inserted into the female connector 2, the guide projections 27 of the male connector 3 are inserted into the male connector guide grooves 13 formed on the inner circumference of the side wall 8 of the fitting hood portion 6.

As shown in FIG. 2, the body portion 17 in front of the female terminal housing portions 19 of the male connector 3 is inserted into the male terminal housing portion 16 of the female connector 2 so that the male terminal portions 7 are electrically connected to the female terminals.

Then, the electric wire regulation cover 4 is attached to the male connector 3 in such a manner as to cover the rear ends of the female terminal housing portions of the male connector 3. Here, the short-side projections 37 of the projections 29 formed at the opening of the electric wire regulation cover 4 are press-fitted between the projection insertion grooves 11 (short-side insertion grooves 14) of the female connector 2 and the outer circumferential surface 20 of the body portion 17 of the male connector 3 in a manner such that the short-side projections 37 slide along the grooves 33 of the projection insertion guide portions 25 of the male connector 3. While the short-side projections 37 are press-fitted into the short-side insertion grooves 14, the long-side projection 35 of the projections 29 is also press-fitted between the outer circumferential surface 20 of the body portion 17 of the male connector 3 and the projection insertion groove 11 (a long-side insertion groove 12).

As described above, the cover body portion 21 is provided with the projections 29 to be inserted between the respective projection insertion grooves 11 of the female connector 2 and the outer circumferential surface 20 of the body portion 17 of the male connector 3. Thus, the gaps between the male connector 3 and the female connector 2 can be filled with the projections 29 formed in the electric wire regulation cover 4 in a manner such that the projections 29 are inserted thereinto. In addition, the thickness of the projections 29 is set to be greater than the projection height of the projection insertion grooves 11 so as to reliably fill the gaps between the female connector 2 and the male connector 3 and prevent the male connector 3 from oscillating inside the female connector 2.

The projection insertion guide portions 25 for guiding the projections 29 formed in the cover body portion 21 into the gaps between the projection insertion grooves 11 of the female connector 2 and the outer circumferential surface 20 of the body portion 17 of the male connector 3, are formed on the side surfaces of the female terminal housing portions 19 of the male connector 3 so as to reliably guide the projections 29 to the projection insertion grooves 11.

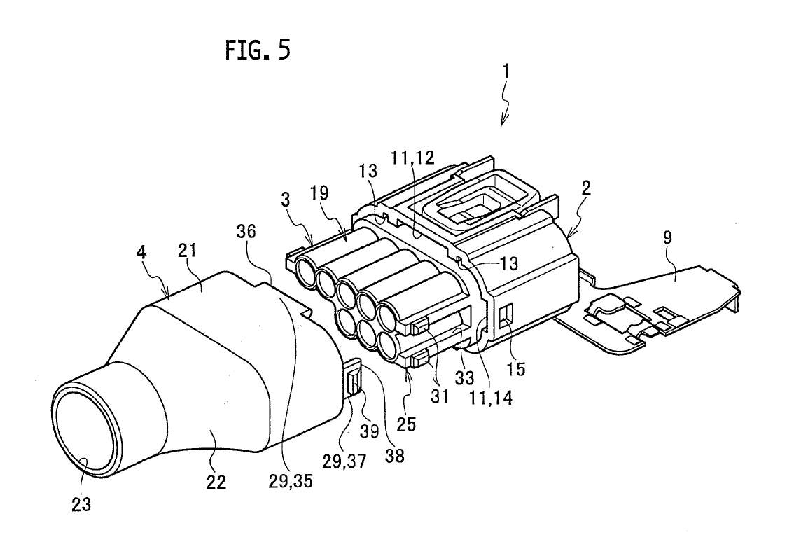

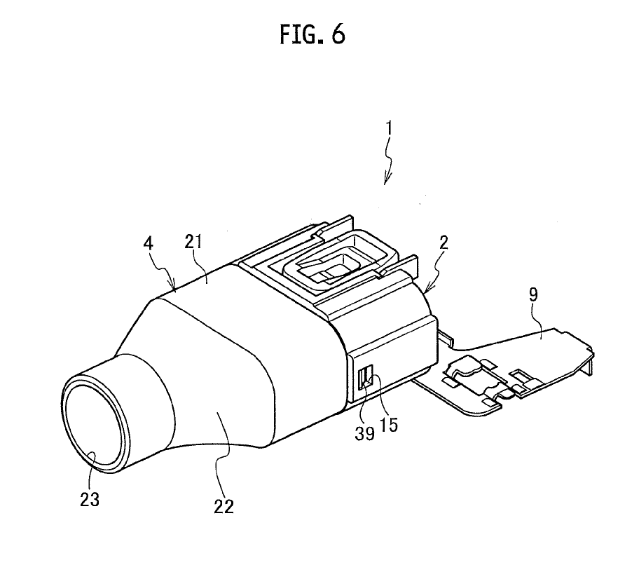

As a modified example of the present embodiment, as shown in FIGS. 5 and 6, the short-side projections 37 of the projections 29 formed in the electric wire regulation cover 4 may be provided with fixed pieces 39 projecting toward the fixing hood portion 6, and the side wall 8 of the female connector 2 may be provided with fixing portions 15.

Namely, the fixed pieces 39 are fixed to the fixing portions 15 so that the projections 29 can be prevented from coming off the projection insertion grooves 11 and the electric wire regulation cover 4 can reliably be fixed to the female connector 2.

In addition, the tips of the fixed pieces 39 may be tapered in a manner such that the thickness thereof gradually increases from the insertion side to the insertion end side. Accordingly, the fixed pieces 39 can be fixed easily to the fixing portions 15.

What is claimed is:

1. A connector comprising:
a female connector including a fitting hood portion provided with male terminal portions projecting therein;
a male connector fitted into the fitting hood portion of the female connector and including female terminal housing portions for housing female terminals to be connected to the male terminal portions of the female connector, the female terminals being connected with a plurality of electric wires drawn out of a rear end portion of the male connector; and
an electric wire regulation cover fixed to the rear end portion of the male connector to collect the plurality of electric wires drawn out of the male connector,
wherein an inner wall of the fitting hood portion of the female connector is provided with a projection insertion groove elongated in an insertion direction of the male connector,
a cover body portion is formed in the electric wire regulation cover to cover the rear end portion of the male connector, and
the cover body portion is provided, on an front end portion thereof, with a projection inserted between the projection insertion groove of the female connector and an outer circumferential surface of the male connector so as to fill a gap between the inner wall of the fitting hood portion and the outer circumferential surface of the male connector.

2. The connector according to claim 1, wherein:
the projection is provided with a fixed piece projecting toward the fitting hood portion of the female connector;
the fitting hood portion of the female connector is provided with a fixing portion to which the fixed piece is fixed; and
the fixed piece is fixed to the fixing portion so that the electric wire regulation cover is attached to the male connector.

3. The connector according to claim 1, wherein the rear end portion of the male connector is provided with a projection insertion guide portion for guiding the projection into the gap between the inner wall of the fitting hood portion and the outer circumferential surface of the male connector.
